(19) United States
(12) Patent Application Publication
(10) Pub. No.: US 2014/0106234 A1
(43) Pub. Date: Apr. 17, 2014

(54) MOLTEN-SALT BATTERY

(71) Applicants: Atsushi Fukunaga, Osaka-shi (JP); Shinji Inazawa, Osaka-shi (JP); Koji Nitta, Osaka-shi (JP); Shoichiro Sakai, Osaka-shi (JP)

(72) Inventors: Atsushi Fukunaga, Osaka-shi (JP); Shinji Inazawa, Osaka-shi (JP); Koji Nitta, Osaka-shi (JP); Shoichiro Sakai, Osaka-shi (JP)

(73) Assignee: SUMITOMO ELECTRIC INDUSTRIES, LTD., Osaka-shi, Osaka (JP)

(21) Appl. No.: 14/124,202

(22) PCT Filed: May 31, 2012
(86) PCT No.: PCT/JP2012/064079

§ 371 Date: Dec. 5, 2013

(30) Foreign Application Priority Data
Jun. 6, 2011 (JP) 2011-126418

(51) Int. Cl. H01M 10/04; H01M 10/39

(52) U.S. Cl. CPC H01M 10/0459; H01M 10/399
USPC 429/246

(57) ABSTRACT

There is provided with a molten-salt battery which can prevent relative positional displacement between a positive electrode or a negative electrode and a separator. Both faces of the negative electrodes are covered with the separators which are formed to bend along a lower end part of the respective positive electrodes. The separators respectively have a V-shaped or U-shaped cross section, a bent part is formed to have a valley-like (groove-like) shape, and the respective bent parts are disposed along a lower side of the positive electrodes. The positive electrodes having both faces covered with the respective separators as described above and the negative electrodes are laminated alternately. The dimension of the separators after being bent is made larger than that of the positive electrodes and the negative electrodes by 1 to 10%.

### CROSS-REFERENCE TO RELATED APPLICATIONS

This application is the national phase under 35 U. S. C. §371 of PCT International Application No. PCT/JP2012/064079 which has an International filing date of May 31, 2012 and designated the United States of America.

### FIELD

The present invention relates to a molten-salt battery wherein a molten salt is used as an electrolyte and, more particularly, to a molten-salt battery including a molten salt which melts at a temperature higher than a room temperature and a separator interposed between a positive electrode and a negative electrode.

### BACKGROUND

In recent years, electric power generation which uses natural energy such as sunlight or wind force has been promoted as means for generating electric power without carbon dioxide emission. Regarding electric power generation using natural energy, it is essential to level the electric power supply to a load, since the electric generating capacity tends to depend on natural conditions such as the climate or the weather and it is difficult to adjust the electric generating capacity according to an electric power demand. In order to level electric energy obtained by electric power generation by charge and discharge, a large-capacity storage battery having high energy density and high efficiency is required.

As a storage battery to meet such conditions, a sodium-sulfur battery which is one type of a molten-salt battery has been put to practical use. A sodium-sulfur battery has many structural constraints and handleablity drawbacks, since a solid molten-salt is used as an electrolyte and the sodium-sulfur battery is utilized in a state where sulfur and sodium polysulfide in positive-electrode active material and sodium in negative-electrode active material are melted at high temperature.

In contrast, some researchers have tried to use a molten salt, which melts at a relatively low temperature equal to or lower than 130° C., as an electrolyte (see Japanese Patent Application Laid-Open No. 2009-67644, for example). Especially, in a molten-salt battery wherein a molten salt having a melting point higher than a room temperature is used as an electrolyte, a battery container is heated in an operating state so as to melt the molten salt and heating is stopped in a pausing state so as to solidify the molten salt.

A common structure of such a molten-salt battery wherein a liquid molten salt is used as an electrolyte is that an electrolyte including a molten salt is impregnated in a separator, in a positive electrode and in a negative electrode, and the separator is sandwiched between the positive electrode and the negative electrode (see Japanese Patent Application Laid-Open No. 2007-273362, for example). The separator has a horizontal and vertical size larger than that of the positive electrode and the negative electrode so that positional displacement of the separator in a direction along a face opposed to the positive electrode and the negative electrode is allowed.

### SUMMARY

In an assembling process step of a molten-salt battery, however, it is difficult to obtain high positioning accuracy in overlapping of a positive electrode, a separator and a negative electrode, and positional displacement may possibly cause a short circuit between the positive electrode and the negative electrode. When a separator having a larger size is employed in order to prevent such a short circuit, this contributes to lowering of the energy density of a molten-salt battery.

Moreover, when melting and solidifying of a molten salt are repeated with operating and pausing of a molten-salt battery, expansion and contraction of the volume of a molten salt may possibly cause problems. For example, regarding a mixed salt composed of some type of anions and sodium and potassium cations, the density in a molten state is 2.15 g/cm³ while the density in a solidified state becomes 1.9 g/cm³ and the volume changes by 10% or more. On the other hand, in the process of heating and cooling of a battery container, uneven temperature change in the battery container is inevitable and melting and solidifying of a molten salt proceeds from a part, causing generation of stress respectively at a positive electrode, a separator and a negative electrode. Therefore, relative positional displacement between the positive electrode, the separator and the negative electrode may possibly be produced and, when such relative positional displacement is produced repeatedly, this causes a short circuit between the positive electrode and the negative electrode.

The present invention has been made in view of such a situation, and an object thereof is to provide a molten-salt battery which can prevent relative positional displacement between a positive electrode or a negative electrode and a separator.

A molten-salt battery according to the present invention is a molten-salt battery comprising a positive electrode and a negative electrode opposed to each other with a separator interposed therebetween wherein a molten salt which melts at a temperature higher than a room temperature is used as an electrolyte, characterized in that the positive electrode and the negative electrode respectively have a plate-like shape, the separator has a sheet-like shape and is formed to bend along a part of a rim part of the positive electrode and the negative electrode, and both faces of the positive electrode or the negative electrode are covered with the bent separator.

In the present invention, both faces of a positive electrode or a negative electrode are covered with a separator which is formed to bend along a part of a rim part of the positive electrode and the negative electrode.

With such a structure, movement of the positive electrode or the negative electrode is regulated by a bent part of the separator. Moreover, assembling of a molten-salt battery is simplified, since the positive electrode (or negative electrode) having both faces which have been preliminarily covered with the separator and the negative electrode (or positive electrode) are opposed to each other.

A molten-salt battery according to the present invention is characterized in that the separator has a V-shaped or U-shaped cross section in a direction crossing a bent part.

In the present invention, the separator has a V-shaped or U-shaped cross section in a direction crossing the bent part of the separator, and the bent part of the separator is formed to have a valley-like (groove-like) shape.

With such a structure, movement of the positive electrode or the negative electrode is regulated further favorably when one side of the positive electrode or the negative electrode having a rectangular plate-like shape, for example, is disposed along the bent part of the separator.

A molten-salt battery according to the present invention is characterized in that the separator is formed to have a bag-like shape.

In the present invention, the separator is formed to have a bag-like shape and the positive electrode or the negative electrode is held in the bag.

With such a structure, the positive electrode and the negative electrode are insulated reliably from each other even when displacement is produced in overlapping in the opposing direction of the positive electrode and the negative electrode.

A molten-salt battery according to the present invention is characterized in that the separator covers both faces of the positive electrode.

In the present invention, both faces of the positive electrode are covered with the separator.

With such a structure, when the bent part of the separator is located at a lower side, active material which falls off the positive electrode is deposited on the bent part of the separator, preventing a short circuit between the positive electrode and the negative electrode and between the positive electrode and the battery container via the active material.

A molten-salt battery according to the present invention is characterized by comprising a plurality of separators, a plurality of positive electrodes and a plurality of negative electrodes.

In the present invention provided with a plurality of positive electrodes, a plurality of separators and a plurality of negative electrodes, a laminating operation for laminating the positive electrodes and the negative electrodes alternately with the separators interposed therebetween accompanied with relative alignment of the positive electrodes and the negative electrodes is facilitated, since both faces of the respective positive electrodes or the respective negative electrodes are preliminarily covered with the separators.

A molten-salt battery according to the present invention is characterized in that the separator is made of material including at least one of glass, ceramic and plastic.

In the present invention, the material of the separator includes at least one type of glass, ceramic and plastic.

Therefore, the separator is chemically stable against a molten salt even at a temperature higher than a room temperature and is mechanically resistant to volume change of a molten salt caused by temperature change and repeated charge and discharge.

A molten-salt battery according to the present invention is characterized in that the separator is made of glass fiber.

In the present invention wherein the separator is non-woven fabric or mesh made of glass fiber, the material can be obtained at a low cost and the separator to cover both faces of the positive electrode or the negative electrode can be formed easily from continuous separator material.

A molten-salt battery according to the present invention is characterized in that a dimension of the separator in a direction crossing an opposing direction of the positive electrode and the negative electrode is larger than a dimension of the positive electrode and the negative electrode in said direction by 1 to 10%.

In the present invention, the dimension of the separator in a direction crossing an opposing direction of the positive electrode and the negative electrode is made larger than that of the positive electrode and the negative electrode by 1 to 10%.

With such a structure, some relative displacement between the positive electrode and the negative electrode is allowed. When the dimension of the separator is larger than that of the positive electrode and the negative electrode by a ratio smaller than 1%, a yield at the time of manufacturing lowers in view of a vibration test, for example. When the dimension of the separator is larger than that of the positive electrode and the negative electrode by a ratio larger than 10%, the molten-salt battery becomes large in size, which causes lowering of energy density.

With the present invention wherein both faces of the positive electrode or the negative electrode are covered with a separator formed to bend along a part of a rim part of the positive electrode and the negative electrode, movement of the positive electrode or the negative electrode is regulated by a bent part of the separator.

Accordingly, it becomes possible to prevent relative positional displacement between the positive electrode or the negative electrode and the separator.

The above and further objects and features will more fully be apparent from the following detailed description with accompanying drawings.

### BRIEF DESCRIPTION OF THE DRAWINGS

FIG. 1 is a perspective view schematically illustrating the structure of a molten-salt battery according to an embodiment of the present invention.

FIG. 2 is a horizontal sectional view at the line II-II in FIG. 1.

FIG. 3 is a top view of a molten-salt battery according to an embodiment of the present invention.

FIG. 4 is a vertical sectional view of a molten-salt battery according to an embodiment of the present invention.

FIG. 5 is a vertical sectional view at the line V-V in FIG. 4.

FIG. 6 is a horizontal sectional view at the line II-II regarding a molten-salt battery according to a modified example of an embodiment of the present invention.

### DETAILED DESCRIPTION

The following description will explain an embodiment of a molten-salt battery according to the present invention in detail with reference to the drawings.

### Embodiment

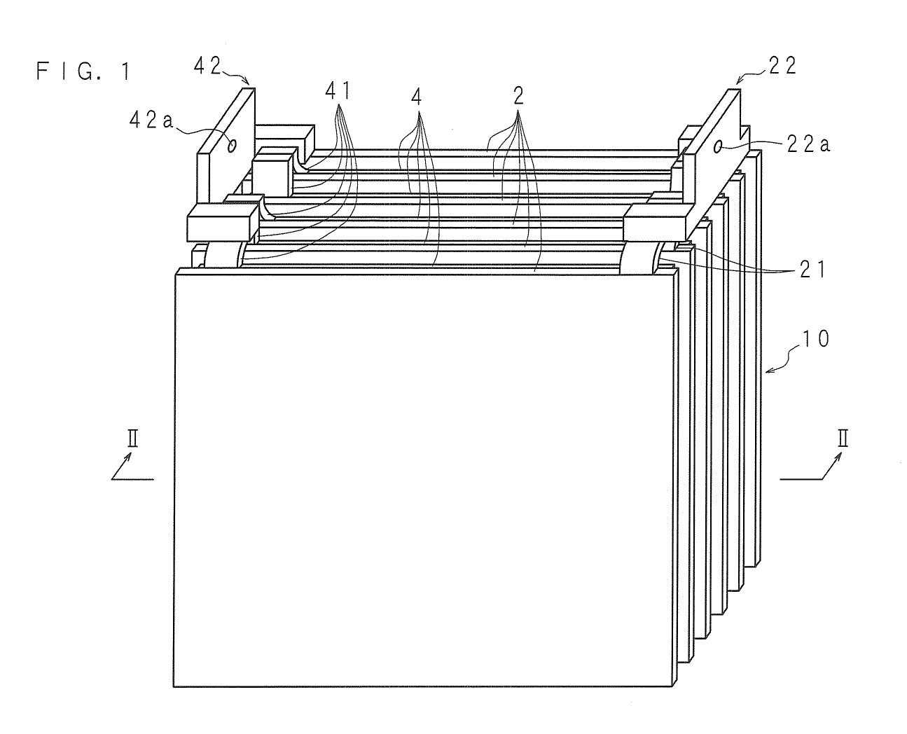

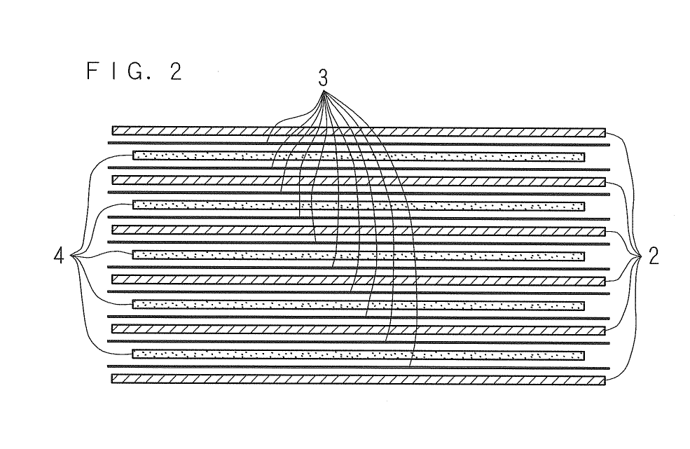

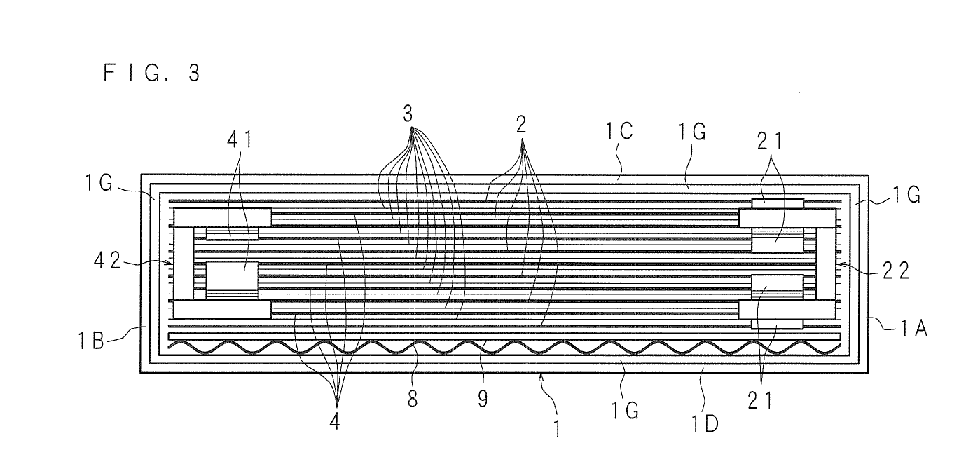

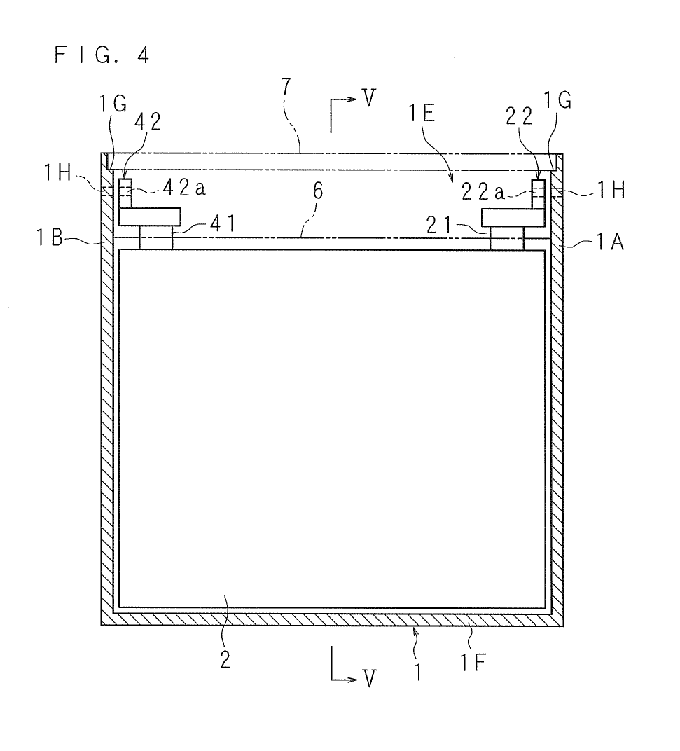

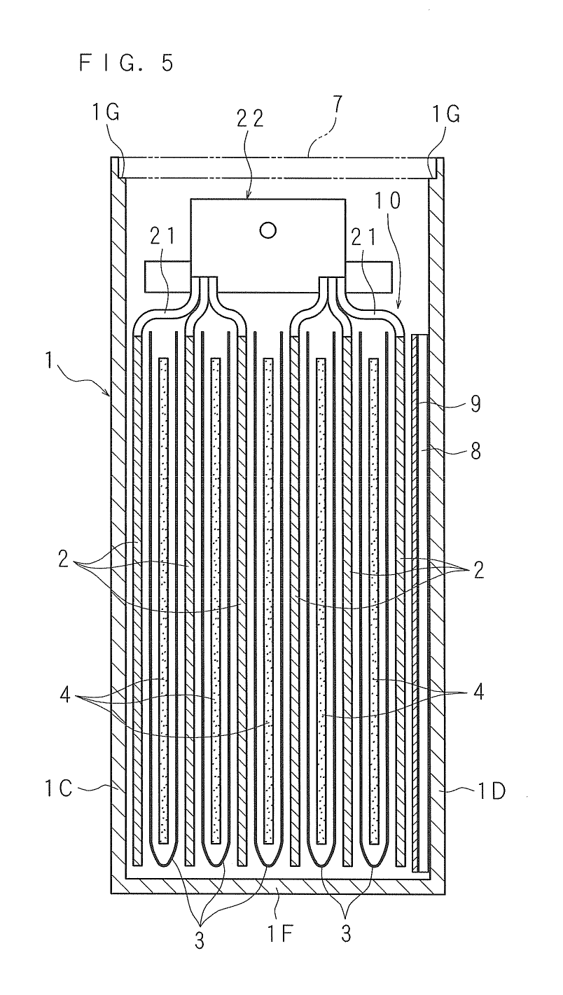

FIG. 1 is a perspective view schematically illustrating the structure of a molten-salt battery according to an embodiment of the present invention, FIG. 2 is a horizontal sectional view at the line II-II in FIG. 1, FIG. 3 is a top view of a molten-salt battery according to an embodiment of the present invention, FIG. 4 is a vertical sectional view of a molten-salt battery according to an embodiment of the present invention, and FIG. 5 is a vertical sectional view at the line V-V in FIG. 4.

In a molten-salt battery of the present invention, a plurality of (six in the drawings) negative electrodes 2, 2, . . . 2 respectively having a rectangular flat plate-like shape and a plurality of (five in the drawings) positive electrodes 4, 4, . . . 4 which respectively have a rectangular flat plate-like shape and have both faces covered respectively with separators 3, 3, . . . 3 (not illustrated in FIG. 1) respectively having a V-shaped vertical cross section are disposed along the vertical direction and laminated alternately in the horizontal direction to be opposed to each other. Negative electrodes 2 and 2 are located at both ends in the lamination direction. One set of a negative electrode 2, a separator 3 and a positive electrode 4 composes one electric generating element, and five electric generating elements and one negative electrode 2 (electric generating elements will include this negative electrode 2 hereinafter) are laminated in the present embodiment and held in a battery container 1 made of an aluminum alloy having a rectangular parallelepiped shape. The inner side of the battery container 1 is preliminarily exposed to insulation treatment by fluororesin coating.

The battery container 1 is provided with two side walls 1A and 1B located at short sides in a planar view, two side walls 1C and 1D located at long sides, a cover 7 to be fitted in an opening 1E at an upper face to cover the opening 1E, and a bottom wall 1F. Inside an upper end part of the side walls 1A, 1B, 1C and 1D, a step part 1G having a vertical dimension equal to the board thickness of the cover 7 is formed over the whole circumference. The cover 7 is a rectangular parallelepiped plate member and has an external dimension which is made substantially equal to or slightly smaller than an internal dimension of the step part 1G of the battery container 1 in a planar view. By fitting the cover 7 from above into the step part 1G of the battery container 1, the cover 7 is fitted in the opening 1E of the battery container 1. FIG. 3 illustrates a state where the cover 7 is taken off.

A spring 8 made of a metal having a corrugated plate-like shape is disposed between the side wall 1D of the battery container 1 and the negative electrode 2 located at one end in the lamination direction of the electric generating elements. The spring 8 is made of an aluminum alloy, biases an inflexible flat plate-like presser plate 9 and presses the negative electrode 2 toward the side of the separator 3 and the positive electrode 4. With reaction thereto, the side wall 1C of the battery container 1 at the opposite side of the spring 8 presses the negative electrode 2, which is located at the other end in the lamination direction, toward the side of the separator 3 and the positive electrode 4. The spring 8 is not limited to a leaf spring made of metal or the like, but may be an elastic body such as rubber, for example.

Regarding an upper end part of the negative electrodes 2, 2, . . . 2, a side closer to one side wall 1A located at a short side of the battery container 1 is joined with a lower end part of rectangular tabs (conductor wires) 21, 21, . . . 21 to be used for taking out electric current. An upper end part of the tabs 21, 21, . . . 21 is joined with inner faces, which are opposed to each other, of a tab lead 22 inflected to have a U-shaped planar view.

Regarding an upper end part of the positive electrodes 4, 4, . . . 4, a side closer to the other side wall 1B located at a short side of the battery container 1 is joined with a lower end part of rectangular tabs 41, 41, . . . 41 to be used for taking out electric current. An upper end part of the tabs 41, 41, . . . 41 is joined with inner faces, which are opposed to each other, of a tab lead 42 inflected to have a U-shaped planar view.

The tab leads 22 and 42 function as external connection electrodes to be used for connecting the electric generating elements with an external electric circuit, and are provided with holes 22a and 42a to be connected with external wiring. Through holes 1H and 1H are formed at positions of the side walls 1A and 1B which are opposed to the holes 22a and 42a. A molten-salt battery having a large battery capacity is obtained, since the electric generating elements are electrically connected in parallel by the tab leads 22 and 42. The tab leads 22 ad 42 are located at a position upper than the liquid level of a molten salt 6 filled in the rectangular parallelepiped battery container 1.

The molten salt 6 is composed of FSA-series (bis (fluorosulfonyl) amide) or TFSA-series (bis (trifluoromethylsulfonyl) amide) anions and sodium and/or potassium cations, but is not limited to this.

The negative electrodes 2, 2, . . . 2 are made of aluminum alloy plates which are plated with tin that is negative-electrode active material. Aluminum is a suitable material for each of positive and negative electrodes and has corrosion resistance to the molten salt 6. The negative electrodes 2, 2, . . . 2 respectively have a thickness of approximately 0.15 mm including active material and dimensions in the vertical direction and the horizontal direction respectively of 100 mm and 120 mm.

The positive electrodes 4, 4, . . . 4 are respectively formed to have a board thickness of approximately 1 mm by employing a porous sheet or a porous body of aluminum as an electric collector and filling and pressing mixture including binder, conduction assistant and NaCrO₂, which is positive-electrode active material, in the electric collector. The dimensions of the negative electrodes 2, 2, . . . 2 in the vertical direction and the horizontal direction are respectively made smaller than dimensions of the positive electrodes 4, 4, . . . 4 in the vertical direction and the horizontal direction in order to prevent generation of a dendrite, and an outer edge of the respective positive electrodes 4, 4, . . . 4 is opposed to a rim part of the negative electrodes 2, 2, . . . 2 with the separators 3, 3, . . . 3 interposed therebetween. The electric collector of the positive electrodes 4, 4, . . . 4 may be non-woven fabric or mesh made of fibrous aluminum, for example.

The separators 3, 3, . . . 3 are made of a porous PTFE (one type of Teflon (registered trademark)) sheet or glass non-woven fabric resistant to the molten salt 6 at a temperature at which the molten-salt battery operates. The separators 3, 3, . . . 3 are impregnated at a position lower than the liquid level of the molten salt 6 by approximately 10 mm, together with the negative electrodes 2, 2, . . . 2 and the positive electrodes 4, 4, . . . 4. In such a structure, some liquid level lowering is allowed.

A molten-salt battery according to the present invention is run at a temperature higher than a temperature at which the molten salt 6 melts, since the molten salt 6 which melts at a temperature higher than a room temperature is used as an electrolyte. The temperature differs depending on the type of a molten-salt 6 to be used, but is normally higher than a room temperature and lower than approximately 100° C. Accordingly, the separators 3, 3, . . . 3 are required to withstand a high operating temperature in comparison with a separator in a common lithium ion secondary battery or the like. Moreover, the separators 3, 3, . . . 3 are required to be chemically stable against the molten salt 6 at a high temperature and to be resistant to volume change of the molten salt 6 caused by charge and discharge of the molten-salt battery and temperature change in operating/pausing of the molten-salt battery.

Based on such a perspective, examples of material applicable to the separators 3, 3, . . . 3 of a molten-salt battery are glass which is a representative example, ceramic such as alumina or zirconia, and various kinds of plastic. As plastic, polyolefin resin and Teflon (trade mark) which are used in a lithium ion secondary battery, and various kinds of engineering plastic having further enhanced heat resistance and intensity can be used. Fiber or film including at least one of these materials becomes applicable to the separators 3, 3, . . . 3 after being processed into a porous sheet (e.g., non-woven fabric, mesh or perforated film). Accordingly, the separators 3, 3, . . . 3 can be glass mesh, or non-woven fabric or mesh made of fibrous alumina, for example.

Regarding the thickness of the separators 3, 3, . . . 3, a range from 30 μm to 60 μm is appropriate for PTFE and a range from 80 μm to 200 μm is appropriate for glass non-woven fabric, for example, since too small thickness tends to cause breakage while too large thickness causes lowering of the energy density of a molten-salt battery. The size of the separators 3, 3, . . . 3 is large enough to cover both faces of the respective positive electrodes 4, 4, . . . 4 after being bent into a V-shaped form, and the horizontal and vertical size of a face opposed to the positive electrodes 4, 4, . . . 4 is made larger than the size of the positive electrodes 4, 4, . . . 4 by 1 to 10%. A yield at the time of manufacturing lowers when the size of the separators 3, 3, . . . 3 is larger than that of the positive electrodes 4, 4, . . . 4 by a ratio smaller than 1%, while energy density of a molten-salt battery lowers to an unacceptable level when the size of the separators 3, 3, . . . 3 is larger than that of the positive electrodes 4, 4, . . . 4 by a ratio larger than 10%.

Since the separators 3, 3, . . . 3 can be formed to have a V-shaped cross section as illustrated in FIG. 5 by a method of folding an elongated rectangular sheet in half in the longitudinal direction, a process step such as welding (heat sealing) to be used for forming separators to have a bag-like shape is unnecessary. The separators 3, 3, . . . 3 may be formed to have a U-shaped cross section after being inflected smoothly. Bent parts of the separators 3, 3, . . . 3 are respectively formed to have a valley-like (groove-like) shape, and the respective bent parts are disposed along a lower side of the positive electrodes 4, 4, . . . 4.

Next, assembling of the electric generating elements and assembling of a molten-salt battery including installation of the electric generating elements into the battery container 1 will be described.

In assembling of the electric generating elements, a laminating operation accompanied with relative alignment of the positive electrodes 4, 4, . . . 4 and the negative electrodes 2, 2, . . . 2 is facilitated, since both faces of the respective positive electrodes 4, 4, . . . 4 are preliminarily covered with the bent separators 3, 3, . . . 3 and therefore movement of the positive electrodes 4, 4, . . . 4 is regulated by the bent parts of the respective separators 3, 3, . . . 3 and the number of the separators 3, 3, . . . 3 decreases by half.

In assembling of a molten-salt battery, the electric generating elements, which are electrically connected in parallel with each other by the tab leads 22 and 42, and the molten-salt 6 are loaded into the battery container 1. In such a case, since movement of the bent parts of the separators 3, 3, . . . 3 are regulated by the respective positive electrodes 4, 4, . . . 4, positional displacement of the separators 3, 3, . . . 3 is rarely produced and the handleability of the electric generating elements is enhanced.

A pair of insulating bushings made of Teflon (trade mark) is then fitted in the through holes 1H and 1H from both sides of the respective side walls 1A and 1B. Bolts are then inserted into each pair of bushings and the respective holes 22a and 42a, and each bolt is screwed and fitted in a nut (the bushings, bolts and nuts are not illustrated). Furthermore, the cover 7 is fitted in the opening 1E of the battery container 1, and a rim part of the cover 7 is welded with the battery container 1 by irradiation with laser light from above, for example.

In a molten-salt battery assembled in such a manner, the side walls 1A and 1B and the tab leads 22 and 42 are electrically insulated from each other and fastened. The respective bolts are electrically insulated from the side walls 1A and 1B but electrically connected with the negative electrodes 2, 2, . . . 2 and with the positive electrodes 4, 4, . . . 4 via the respective tab leads 22 and 42, the tabs 21, 21, . . . 21 and the tabs 41, 41, . . . 41. Accordingly, the respective bolts function as a positive electrode terminal and a negative electrode terminal.

With the structure described above, when the whole battery container 1 is heated to 85° C. to 95° C. using external heating means which is not illustrated, the molten salt 6 melts and it becomes possible to charge and discharge the molten-salt battery. When the molten-salt battery is charged by applying positive voltage to the positive electrode terminal with respect to the negative electrode terminal from outside, sodium ions transfer from the positive electrodes 4, 4, . . . 4 through the separators 3, 3, . . . 3 to the negative electrodes 2, 2, . . . 2 and therefore both of the positive electrodes 4, 4, . . . 4 and the negative electrodes 2, 2, . . . 2 expand.

On the other hand, when the molten-salt battery is discharged by connecting an external load between the positive electrode terminal and the negative electrode terminal, sodium ions transfer from the negative electrodes 2, 2, . . . 2 to the positive electrodes 4, 4, . . . 4, and both of the positive electrodes 4, 4, . . . 4 and the negative electrodes 2, 2, . . . 2 contract. Although such volume change caused by charge and discharge elongates and contracts the positive electrodes 4, 4, . . . 4 and the negative electrodes 2, 2, . . . 2 in the thickness direction, the elongation and contraction are absorbed by elongation and contraction of the spring 8.

When volume change of the positive electrodes 4, 4, . . . 4 caused by charge and discharge of the molten-salt battery is repeated, active material sometimes falls off the electric collector of the positive electrodes 4, 4, . . . 4. Even in such a case, the active material which has fallen is deposited on the bent parts of the separators 3, 3, . . . 3, since the bent parts of the separators 3, 3, . . . 3 are located below the respective positive electrodes 4, 4, . . . 4. Accordingly, it is possible to prevent a short circuit between the positive electrodes 4, 4, . . . 4 and the negative electrodes 2, 2, . . . 2 and between the positive electrodes 4, 4, . . . 4 and the battery container 1 via the active material.

Moreover, since the horizontal and vertical size of a face, which is opposed to the positive electrodes 4, 4, . . . 4, of the separators 3, 3, . . . 3 is larger than the size of the positive electrodes 4, 4, . . . 4 by 1% or more, a short circuit is not produced between the positive electrodes 4, 4, . . . 4 and the negative electrodes 2, 2, . . . 2 even when volume change of the positive electrodes 4, 4, . . . 4 and the negative electrodes 2, 2, . . . 2 and external factors such as vibration applied to the molten-salt battery cause relative positional displacement between the positive electrodes 4, 4, . . . 4 and the negative electrodes 2, 2, . . . 2.

When the size of the separators 3, 3, . . . 3 is smaller than 100 mm, the size of the separators 3, 3, . . . 3 is made larger than the size of the positive electrodes 4, 4, . . . 4 by 1 mm or more, so as to prevent a short circuit reliably.

With the present embodiment described above, both faces of a positive electrode are covered with a separator formed to bend along a lower end part of the positive electrode.

With such a structure, movement of the positive electrode is regulated by a bent part of the separator.

Accordingly, it becomes possible to prevent relative positional displacement between the positive electrode and the separator. Moreover, it becomes possible to simplify assembling of a molten-salt battery, since a positive electrode having both faces which have been preliminarily covered with a separator and a negative electrode are opposed to each other.

More specifically, by disposing a bent part of a separator having a cross section inflected or curved downward along a lower end part of a positive electrode, displacement of a positive electrode toward a bent part formed at a lower part of a separator is regulated as an effect arising from the relative positional relationship between the positive electrode and the separator. Similarly, displacement of a positive electrode obliquely downward is also regulated. When a positive electrode is fixed to a battery container indirectly via a tab and a tab lead as in a molten-salt battery according to the present embodiment, upward displacement in relative displacement of a separator with respect to a positive electrode is regulated by a bent part of the separator, and downward displacement is regulated by a bottom part of a battery container.

Moreover, a separator has a V-shaped or U-shaped cross section and a bent part of the separator is formed to have a valley-like (groove-like) shape.

Accordingly, it becomes possible to regulate movement of a positive electrode further favorably, by disposing a lower side of a rectangular flat plate-like positive electrode along a bent part of a separator.

Furthermore, since both faces of a positive electrode is covered with a separator and active material which has fallen off the positive electrode is deposited on a bent part located at a lower side of the separator, it becomes possible to prevent a short circuit between a positive electrode and a negative electrode and between a positive electrode and a battery container.

Furthermore, since positive electrodes having both faces which have been preliminarily covered with separators and negative electrodes are laminated alternately, a lamination operation accompanied with relative alignment of the positive electrodes and the negative electrodes can be facilitated.

Furthermore, since the material of the separator includes glass, the separator can be chemically stable against a molten salt even at a high temperature and mechanically resistant to volume change of the molten salt.

Furthermore, since the separator is made of low-cost glass fiber, a separator to cover both faces of the positive electrode is formed easily from continuous separator material and it becomes possible to obtain, at a low cost, a positional displacement preventing effect equivalent to that of a bag-like separator.

Furthermore, since the dimension of the separator after being bent is made larger than that of the positive electrode and the negative electrode by 1 to 10%, it becomes possible to allow some relative displacement between the positive electrode and the negative electrode.

Although both faces of the respective positive electrodes 4, 4, . . . 4 are covered with the separators 3, 3, . . . 3 in the present embodiment, both faces of the respective negative electrodes 2, 2, . . . 2 may be covered with the separators 3, 3, . . . 3 instead. In such a case, it becomes possible to prevent relative positional displacement between the negative electrodes 2, 2, . . . 2 and the separators 3, 3, . . . 3.

### Modified Example

Although the separators 3, 3, . . . 3 in the above embodiment is formed to have a V-shaped or U-shaped vertical cross section as illustrated in FIG. 5, it is further preferable to seal a rim side part and form the separators to have a bag-like shape. In such a case, the present invention is not limited to separators having a V-shaped or U-shaped vertical cross section.

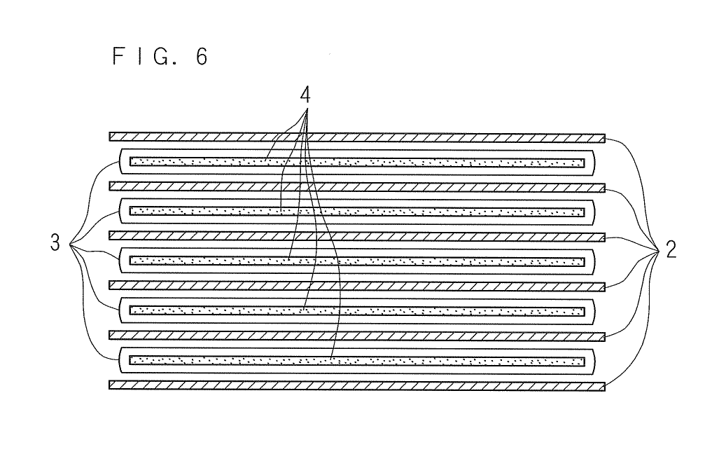

FIG. 6 is a horizontal sectional view at the line II-II regarding a molten-salt battery according to a modified example of an embodiment of the present invention.

In the present modified example, a rim part of the separators 3, 3, . . . 3 excluding an opening at an upper part and a bent part at a lower part is glued or welded by heating, for example, so that lateral sides of the positive electrodes 4, 4, . . . 4 are also surrounded as illustrated in FIG. 6.

In such a case, a process of sealing a rim side part is facilitated by employing a thermoplastic as the material of the separators 3, 3, . . . 3, for example.

By forming the separators 3, 3, . . . 3 to have a bag-like shape as described above, it becomes possible to insulate reliably the positive electrodes and the negative electrodes from each other.

The embodiment disclosed herein is to be considered in all respects as illustrative and not restrictive. The scope of the invention is defined by the appended claims rather than by the description preceding them, and all changes that fall within metes and bounds of the claims, or equivalence of such metes and bounds thereof are therefore intended to be embraced by the claims.

1-8. (canceled)

9. A molten-salt battery comprising a positive electrode and a negative electrode opposed to each other with a separator interposed therebetween wherein a molten salt which melts at a temperature higher than a room temperature is used as an electrolyte, wherein:
the positive electrode and the negative electrode respectively have a plate-like shape,
the separator has a sheet-like shape and is formed to bend along a part of a rim part of the positive electrode and the negative electrode, and
both faces of the positive electrode or the negative electrode are covered with the bent separator.

10. The molten-salt battery according to claim 9, wherein the separator has a V-shaped or U-shaped cross section in a direction crossing a bent part.

11. The molten-salt battery according to claim 9, wherein the separator is formed to have a bag-like shape.

12. The molten-salt battery according to claim 9, wherein the separator covers both faces of the positive electrode.

13. The molten-salt battery according to claim 9, wherein a plurality of separators, a plurality of positive electrodes and a plurality of negative electrodes are provided.

14. The molten-salt battery according to claim 9, wherein the separator is made of material including at least one of glass, ceramic and plastic.

15. The molten-salt battery according to claim 14, wherein the separator is made of glass fiber.

16. The molten-salt battery according to claim 9, wherein a dimension of the separator in a direction crossing an opposing direction of the positive electrode and the negative electrode is larger than a dimension of the positive electrode and the negative electrode in said direction by 1 to 10%.
